(19) United States
(12) Patent Application Publication
(10) Pub. No.: US 2025/0193202 A1
(43) Pub. Date: Jun. 12, 2025

(54) METHOD AND SYSTEM OF PROVIDING ACCESS CONTROL TO RESOURCES BASED ON ROSTER-SCOPED ROLES

(71) Applicant: Microsoft Technology Licensing, LLC, Redmond, WA (US)

(72) Inventors: Abhijit Chandrashekhar PATHAK, Bangalore (IN); Sudip HAZRA CHOUDHURY, Bangalore (IN); Shanmuga Sundaram MAHENDRAN, Bangalore (IN); Nandini Bhavasar NAYAK ANANTHA PADMANABHA RAO, Bangalore (IN); Vladimir Vladimirovich GREBENIK, Redmond, WA (US)

(73) Assignee: Microsoft Technology Licensing, LLC, Redmond, WA (US)

(21) Appl. No.: 18/531,041

(22) Filed: Dec. 6, 2023

(51) Int. Cl. H04L 9/40

(52) U.S. Cl. CPC H04L 63/105; H04L 63/101; H04L 63/104

(57) ABSTRACT

A system and method for providing access control to one or more resources based on roster scoped roles includes generating, via a group management system, a group instance for a group for use in an application, the group including a plurality of group members, and receiving selection of roles for one or more of the plurality of group members. Access rights for the selected roles are retrieved from an application manifest associated with the application and an access rights list instance is generated for the group for storing a list of group members, the group member's selected roles and access rights associated with the selected roles. The access rights list instance is then stored to an access management data structure, and access to the group instance or group connected resources associated with the group is provided based on the access rights list.

### BACKGROUND

Users in many computer environments are assigned roles that are each associated with specific access rights to one or more resources. For example, in a computing device, one user is often assigned the role of administrator and other individuals can be added as users. The user having the administrator role may be able to access all the locally stored files and may also have the right to change settings and other parameters of the computing device, while the other users may have limited access to the locally stored files and may not be able to make any changes to the settings of the computing device. Once these roles are assigned, they are static and do not change depending on circumstances and other variables. While such role assignments and their corresponding access rights are useful in many instances, they do not correspond with real world situations in which change in circumstances often changes the role a user plays. For example, in collaborative environments, one individual may play different roles in different situations. Yet, currently available systems do not provide the ability to assign different and specifically needed roles to different users, as needed.

Hence, there is a need for improved systems and methods of providing access control to various resources based on contextual roles.

### SUMMARY

In one general aspect, the instant disclosure presents a data processing system having a processor and a memory in communication with the processor wherein the memory stores executable instructions that, when executed by the processor, cause the data processing system to perform multiple functions. The functions include generating, via a group management system, a group in a collaborative environment provided in an application by generating a group instance for the group; retrieving one or more roles and one or more access rights associated with the one or more roles from an application manifest of the application; storing the retrieved one or more roles and the one or more access rights associated with the one or more roles into an access control list for the group instance; generating a group connected resource instance for the group instance based on the application manifest; and storing the one or more roles and one or more access rights associated with the one or more roles' access rights to the group connected resource instance into an access control list for the group connected resource instance.

In yet another general aspect, the instant disclosure presents a method for providing access control to one or more resources based on roster scoped roles. In some implementations, the method includes generating, via a group management system, a group in a collaborative environment provided in an application by generating a group instance for the group; retrieving one or more roles and one or more access rights associated with the one or more roles from an application manifest of the application; storing the retrieved one or more roles and the one or more access rights associated with the one or more roles into an access control list for the group instance; generating a group connected resource instance for the group instance based on the application manifest; storing the one or more roles and one or more access rights associated with the one or more roles' access rights to the group connected resource instance into an access control list for the group connected resource instance; and providing access to at least one of the group instance or a group connected resource associated with the group based on the access rights list instance.

In a further general aspect, the instant application describes a non-transitory computer readable medium on which are stored instructions that when executed cause a programmable device to perform functions of generating, via a group management system, a group in a collaborative environment provided in an application by generating a group instance for the group; retrieving one or more roles and one or more access rights associated with the one or more roles from an application manifest of the application; storing the retrieved one or more roles and the one or more access rights associated with the one or more roles into an access control list for the group instance; generating a group connected resource instance for the group instance based on the application manifest; and storing the one or more roles and one or more access rights associated with the one or more roles' access rights to the group connected resource instance into an access control list for the group connected resource instance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 is a diagram showing an example of a resource and collaboration partner services installed in a workspace management software installed for an organization.

FIG. 3. depicts an example of a collaboration partner engaging with a contextual role management system.

FIGS. 4A-4F are flow diagrams depicting example methods for enabling and handling access control to various resources based on roster-scoped roles.

FIG. 5A is a flow diagram depicting an example method for creating a group and group connected resources that utilize roster-scoped roles.

FIG. 5B is a flow diagram depicting an example method for authorizing access to a group membership and metadata.

FIG. 5C is a flow diagram depicting an example method for authorizing a user's access to a group connected resource.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

Different people play different roles in various spheres of collaboration they participate in. For example, the same individual may have the role of a child with respect to their parents, the role of employee to their employer, the role of volunteer in an area of their interest, the role of a listener in a support group and the role of a parent to their children. Thus, the role a person plays can constantly change depending on the context or the sphere of collaboration. Similar changes in circumstance can lead to changing roles in virtual environments. For example, in a virtual brownbag event, a first user can have the role of the speaker. This role and any permissions or access rights associated with this role are effective only to this brown bag event and on this event's group membership. The first user's roles outside this brownbag event are not related to the role at the brownbag event. For example, the first user may be an attendee in another virtual brownbag event and hence permissions assigned to him will correspond with the attendee role in that event. Thus, roles are not absolute, but contextual and collaboration specific, and often have no relevance outside of a particular collaboration instance. Moreover, collaboration roles are contextual, meaning that they are context bound to a particular scenario and duration coinciding with the lifespan of the collaboration. However, current directory mechanisms do not allow defining roles that are group scoped. Current computer environments also manage role assignments in a manner that is fixed (e.g., Azure groups only have owner and member) and not changeable based on circumstance or context. As such, the roles cannot be changed based on the needs of the collaboration. As a result, the roles do not correspond to real world scenarios. Yet, there are many situations, in particular in collaborative environments, in which the use of contextual roles could improve the functionality of the computing environment, reduce use of computing resources such as memory and bandwidth that may otherwise be needed to provide access to certain resources to specific individuals, and to improve the user experience. Thus, there exists a technical problem of lack of mechanisms for providing role definitions that are contextual and/or changeable based on the collaboration instance.

To address these technical problems and more, in an example, this description provides technical solutions for enabling a software program to form groups for collaboration and associate resources with the group. The technical solution facilitates definition of additional roles, associating the roles with access rights and ensuring role-based access control over group and/or group connected resources. In an example, this involves the user of a system and method that defines roster-scoped roles and associates the roles with access rights to group and group connected resources. As such, the roles are contextual and tied to specific collaboration events or contexts. Moreover, the technical solution provides a system and method of role-based access control over group and group connected resources when users with certain roster-scoped roles attempt to access the group and/or group connected resources. Thus, the technical solution offers a system for providing roster-scoped roles that are contextual and changeable depending on the collaboration context. The technical solution provides a cohesive architecture that works with various elements of a computing environment to provide changeable roster-scoped roles that have different access rights to specific resources.

In this manner, the technical solution described herein addresses the technical problem of lack of mechanisms for assigning different roles to a user in the same software application in different scenarios or collaboration contexts and lack of mechanisms for enabling users to manage role assignments based on their needs. The technical solution utilizes a system that works with a collaboration partner, various resource partners, a directory system, a groups platform and/or an access control system to enable role assignments for different collaboration instances (e.g., different groups, different events, etc.). This provides the technical advantage of more efficient computation and use of computing resources, such as memory and processor resources, for managing access rights to services and/or data resources. The technical effects at least include (1) improving the operation of computing systems and software programs by enabling access to collaboration contexts, software applications and/or services, and/or data resources based on context and user needs; (2) improving accuracy and efficiency of managing user roles and access rights; and (3) improving user experience in virtual collaborative environments.

The terms “directory” as used herein refers to a system that tracks and stores identities and metadata for one or more identities used within an enterprise. The term “identify” refers to applications, devices, users, groups, meeting rooms and the like associated with an entity (e.g., an enterprise). The term “resource” as used herein refers to a usable and manageable entity that is accessible and can be used to realize a scenario. For example, a group instance that represents a virtual event, a calendar instance associated with the group such as the group calendar and a data storage site associated with the group instance represent resources. The term “group connected resource” refers to any resources that are associated with a group and/or share a group roster. For example, a data storage site associated with a virtual event and the virtual event itself can both be associated with a group of participants and/or invitees to the virtual event. Thus, both the cloud-storage site and the virtual event have the roster of the meeting participants and/or invitees in common and can be referred to as group connected resources.

The term “collaboration partner” as used herein refers to a software application or software as service that is generated in a way that provides new ways of collaboration within a group of users. While providing a new collaboration experience, a collaboration partner may use services offered by resource partners. In an example, a collaboration partner is a directory application. For example, Microsoft Teams® uses services offered by resource partners such as SharePoint®, Planner, Exchange®, and Calendar. A Teams application instance is provisioned per tenant. The term “resource partner” as used herein refers to a software application or software as service that publishes Web Application Programming Interfaces (APIs). Web APIs offer functionality around perceived resources. In an example, a resource partner is a directory application. For example, SharePoint exposes APIs to manage files stored within a service storage. The SharePoint application instance is provisioned per tenant.

The term “group owner” or “owner” refers to a user that creates a group and receives a specific set of permissions as a creator. The owner can delete the group. All owners are users recognized in a directory. Every group participant is either an owner or a member of the group. The term “group member” refers to a group participant added by the group owner. Members can read the group roster and metadata and/or leave the group. All members are also users that are recognized in the directory. The term “roster role” or “roster-scoped role” refers to roles of each group members. Roster roles may have access rights over group instance and/or group connected resources. For example, an organizer may be the group owner who can add users to the group. Scheduler and content manager are examples of roster roles having access rights over group connected resources like group calendar and group storage site. Users with a certain roster role belong to that role sub-group within the group. The term “role sub-group” refers to role-based sub-groups within a group. For example, all group owners belong to ‘Owner's sub-group’, and all members belong to ‘Members Sub-group’. Role sub-groups are not nested groups. The sub-group arrangement is logical.

The term “access control list” or ACL as used herein refers to a list of identities and their corresponding access rights for a resource. The ACL is typically stored along with a resource. For example, a file item ACL may store {User/Group/Application, read/write/read.write/execute}. An ACL may also function as a property of a group instance where the ACL lists users within the group and their access rights on the group instance and metadata. When a resource is accessed, that resource's ACL is checked against the caller identity to determine if access is authorized.

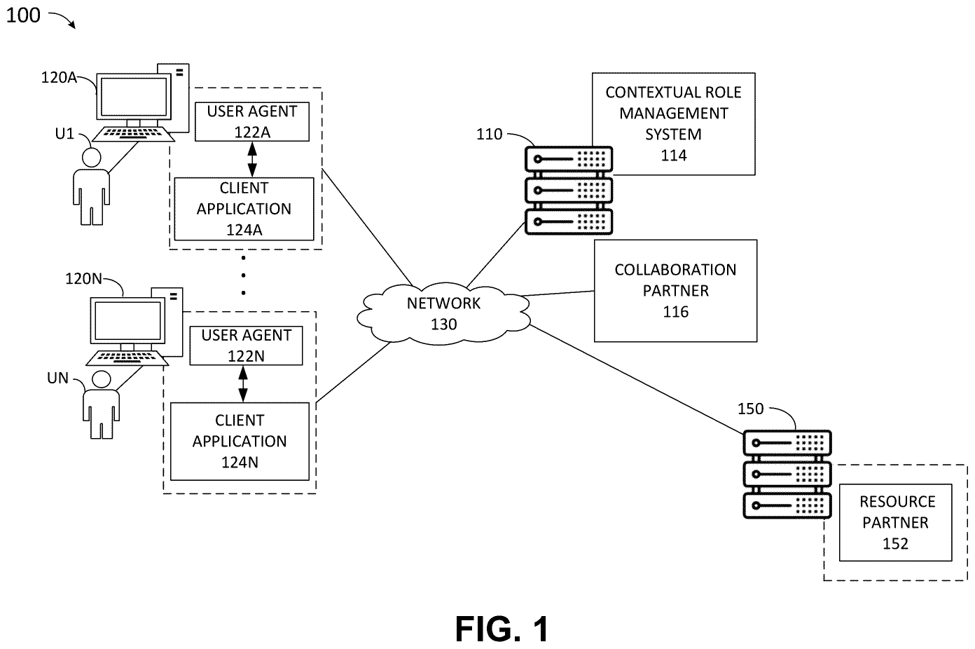

FIG. 1 illustrates an example system 100, upon which aspects of this disclosure may be implemented. The system 100 includes a server 110 which is connected to or includes a contextual role management system 114. The server 110 may include a plurality of servers that work together to deliver the functions and services provided by various services or applications. The server 110 may operate as a cloud-based server for offering contextual role management services. In some implementations, server 110 operates as a shared resource server located at an enterprise accessible by various computer client devices such as one or more of the client devices 120A-120N (referred to collectively and/or individually, for ease of reference, as client device 120).

The contextual role management system 114 helps a collaboration partner 116 to define role to access rights mapping. Access rights may be on group roster or on connected resources. The contextual role management system 114 also helps a collaboration partner 116 to assign roles to different users in a group. The contextual role management system 114 also authorizes access to group membership and metadata. Group connected resource access is authorized by the resource partner 152 with help of the contextual role management system 114.

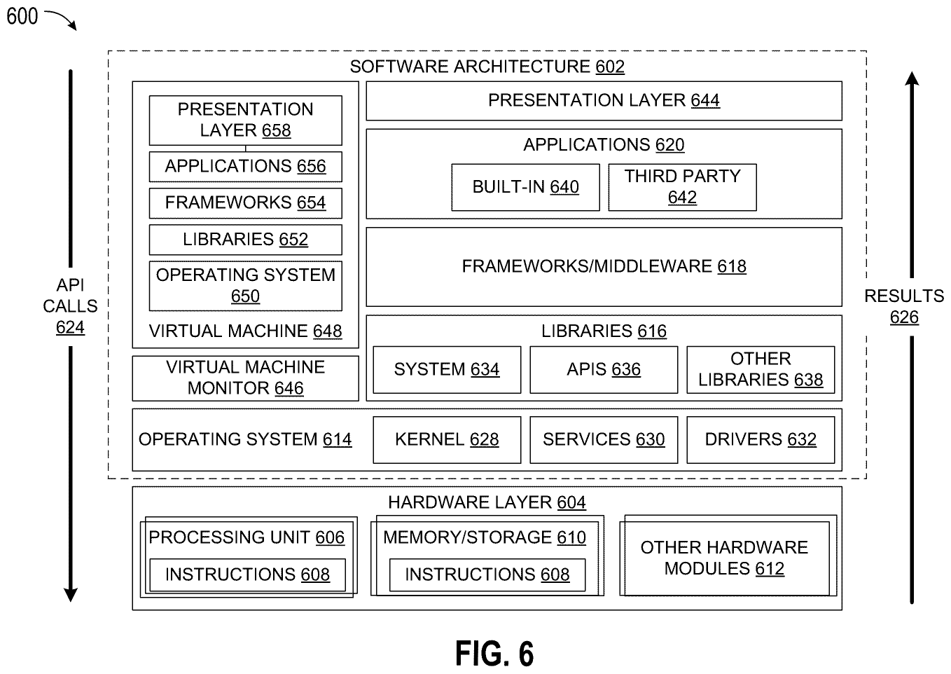

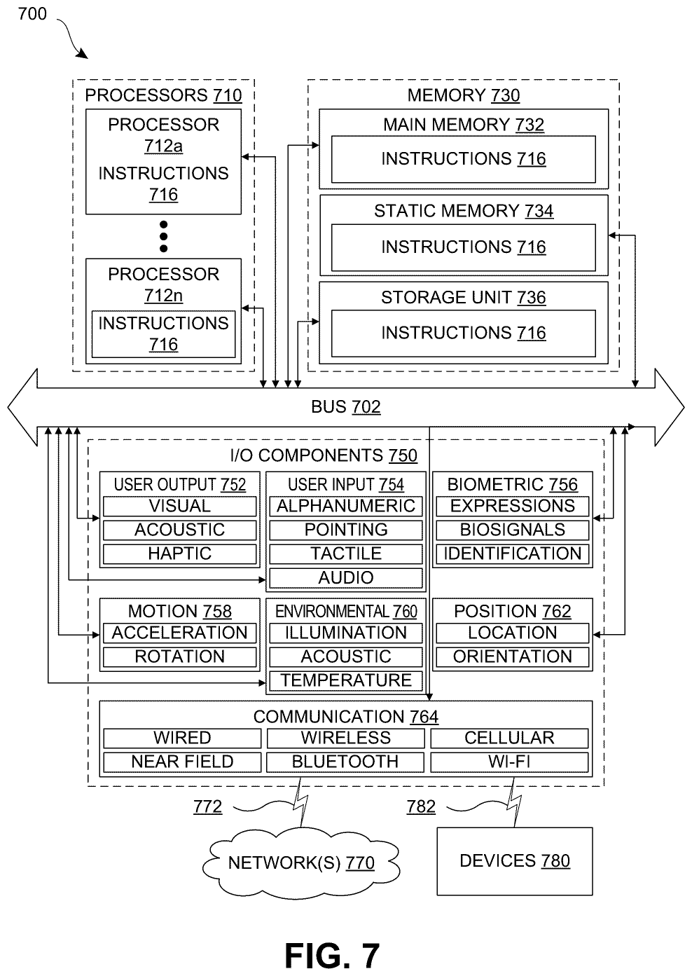

Each of the client devices 120A-120N are connected to the server 110 via a network 130. The network 130 may be a wired or wireless network(s) or a combination of wired and wireless networks that connect one or more elements of the system 100. The client devices 120A-120N may be any computing device having or being connected to input/output elements that enable a user to interact with various applications and services. Examples of suitable client devices 120A-120N include but are not limited to personal computers, desktop computers, laptop computers, mobile telephones, smart phones, tablets, phablets, smart watches, wearable computers, gaming devices/computers, televisions, and the like. The internal hardware structure of a client device is discussed in greater detail in regard to FIGS. 6 and 7.

Each of the client devices 120A-120N may be associated with a different user such as users U1-UN (referred to collectively as user U). Each of the users U1 to UN can engage with the collaboration partner services to collaborate with other users over the network 130. In some implementations, a client device 120 is associated with a user U who may be a group owner that generates a group for an event or another context. The user U may utilize a software service such as the collaboration partner 116 or client application 124 to generate a new group instance, add users to the group as members and assign roles to the group members. Collaboration partner 116 creates a collaboration instance for interacting users. The collaboration instance is backed by a group. Group hosts a roster of users collaborating. Collaboration partner 116 provisions resources necessary for collaboration. These resources may be provided by the resource partner 152. Collaboration partner 116 also lets users assign different roles to users collaborating. These roles come with different access rights. Applications 124A-124N are native applications that are installed on one of the client devices 120. Collaboration partner 116 represents online applications/services that are executed on a server and are provided via an online service or installed application. In some implementations, web applications communicate via the network 130 with a user agent 122A-122N, such as a browser, executing on the client device 120. The user agent 122A-122N allows the user to interact with the collaboration partner 116 and may enable the collaboration partner 116 to provide data to or receive data from the user U.

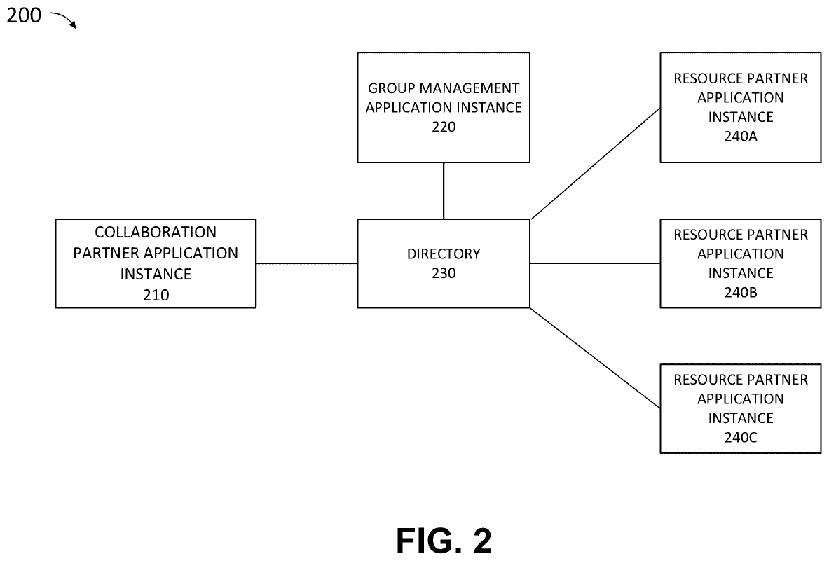

FIG. 2 is a diagram showing an example of a typical organization productivity software suit installation with resource partners provisioned for usage of organization identities. In the example computing environment 200, an organization has a collaboration partner application instance 210, which is an instance of a collaboration partner created for the organization. When an organization productivity software suite (e.g., Microsoft 365 or Google Workspace) is installed, the productivity suit includes a directory 230 which stores identities within the organization. These identities include users, groups, meeting rooms, devices and more. The directory 230 also stores details about identities metadata such as application configuration files, group metadata like group icon, name, access control lists for groups and so forth. In the organization productivity software suit installation, one or more resource partner applications such as resource partner application instances 240A, 240B and 240C are provisioned and there can be one or more collaboration partner application instances, such as the collaboration partner application instance 210.

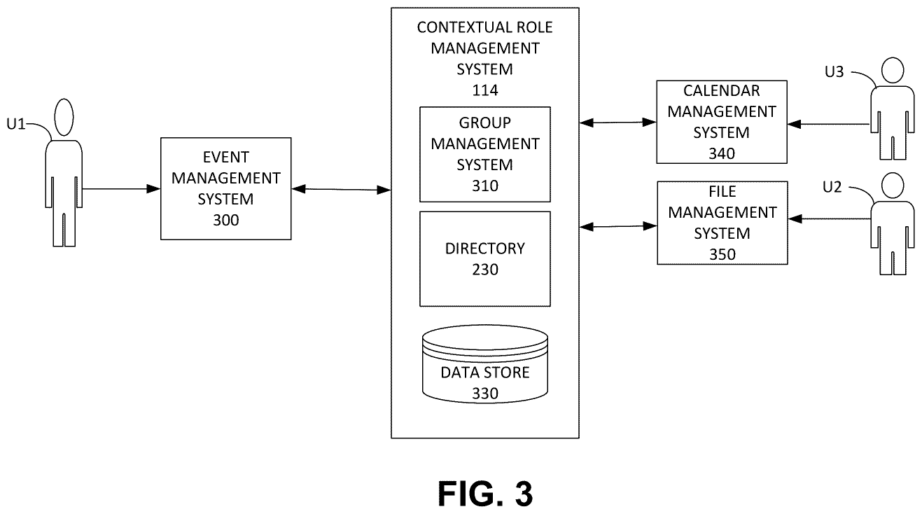

FIG. 3. depicts an example of a system where there is a collaboration partner collaborating with two resource partners to build a new collaboration experience. It should be noted that while the example collaboration partner depicted in FIG. 3 will be used throughout this disclosure, this provides only one example of a collaboration partner and resource partners, and many other types of collaboration partners and resource partners can be used. In some implementations, the event management system 300 provides a user interface (UI) screen to create and manage events. The user U1 uses the UI screen of the event management system 300 to create an event. Every event needs a calendar instance to manage the schedule. This is facilitated by the calendar management system 340. An event also needs a file store to keep files for the event. This is facilitated by the file management system 350. Every event is backed by a group of people that schedule it or attend it. In this manner, the event management system 300 helps build a new collaboration experience for virtual events. The event management system 300 utilizes group constructs to back the event roster.

The event management system 300 is a collaboration partner that engages with the contextual role management system 114 to provide a configuration document which includes resource partners like the calendar management system 340 and file management system 350 which the event management system 300 needs to build the collaboration experience. The configuration document also includes roster-scoped roles and access rights mapping defined by the event management system 300 over resources provided by resource partners. For example, the document may define a Scheduler role and map calendar.readwrite access right to the Scheduler role, or a Coordinator role and map group.readwrite access right to the Coordinator role. The event management system 300 engages with the contextual role management system 114 for creating groups for event instances, adding users to a group and assigning them different roles as per the configuration document discussed above. The contextual role management system 114 includes a group management system 310 which is responsible for managing groups. In some implementations, the group management system 310 exposes Create, Update and Delete (CRUD) APIs for group metadata and membership. The group management system 310 may also maintain a roles to permissions mapping, such that users with assigned roster roles (e.g., scheduler) are authorized to invoke permitted web APIs. (e.g., calendar edit).

The group management system 310 supports group CRUD and membership CRUD. The group management system 310 also provisions group connected resources. As part of group creation, the group management system 310 stores roster-scoped role and permissions mapping on a group instance ACL. As part of group connected resource provisioning, the group management system 310 stores roster-scoped role and permissions mapping on a calendar ACL. For example, if a Scheduler role has calendar.readwrite and group.read access right, the group ACL will have the {Scheduler:group.read}access right and the group connected calendar instance will have the {Scheduler:calendar.readwrite}access right.

In some implementations, the calendar management system 340 exposes APIs to create a calendar instance and associate the calendar instance with the group instance. The calendar management system 340 also exposes one or more access rights to manage events created within a calendar instance. The calendar management system 340 maintains an access control list per calendar instance, i.e., list of identity and access rights over the calendar instance. For example, if Group1:Scheduler has calendar.readwrite access over the calendar C1, this would mean all users with the scheduler role in Group1 have calendar.readwrite access on the calendar instance C1. The calendar management system 340 also exposes APIs to manage events within calendar instance. Calendar management system authorizes access to events within the calendar by comparing the caller's identity, against the calendar instance ACL. Identity directly may have event access (e.g., U3:Calendar.readwrite on C1 ACL), or may have access because the user is a member of the Scheduler role-subgroup (e.g. Scheduler.Group1:Calendar.readwrite on C1 ACL).

In some implementations, the event management system 300 communicates with a directory 230 about different services (e.g. calenda management system to manage event calendar and file management System to manage files associated with an event) it needs as part of the group or event instance. These requirements may also be included in the configuration document transmitted from the event management system 300 to the contextual role management system 114. This configuration document may be an event management service application manifest or be in a different format. The directory 230 may be a directory of users in a computing environment. In some implementations, the directory 230 tracks information about identities in an organization such as users, groups, applications, devices, meeting rooms and the like. In alternative implementations, instead of the directory, a separate access management structure that stores data about users and access rights is used. The access management structure can be any data structure that stores information about identities and their associated role-based access rights. The directory 230 tracks application configuration documents for the event management system 300, calendar management system 340 and file management system 350 along with groups created by the event management system 300. The directory 230 also stores additional metadata for every identity (e.g., Group ACL) and application configuration file or application manifest.

The event management system 300 may also confirm usage of roster scoped roles for groups created by the event management system 300. In an example, for an event instance, the event management system 300 defines roster scoped roles such as coordinator, scheduler, content manager, and attendee. The event management system 300 associates each of these roles with specific access rights to resources connected with each group and/or event. For example, the access rights may determine that a content manager has a right to write on the file management system 350, a scheduler has a right to create and edit the event invitation on the group calendar instance, and a coordinator has a right to add/remove attendees to the group. The user U1 interacts with the event management system 300 to create an event and the event management system 300 creates a group to back the event roster. The user U1 may also add other users to the group and assign roles to each of those users. Some of the roles may allow the other users to add/remove users and/or edit roles of other users.

In order to create an event, the event management system 300 calls utilizes one or more group management system APIs for managing group membership and membership access rights (e.g., CRUD). The group management system 310 creates the group instance and restricts the roster roles assigned to the group instance to those that are configured in the application manifest of the event management system 300. The user U1 creates an event, and the event management system 300 in turn creates a group backing the event roster. The user U1 then adds users U2 and U3 to the event roster and assigns them specific roles e.g., Content Manager for U2 and Scheduler for U3. The group management system 310 then provisions the file management system 350 by calling a file management system service API and adds permissions on the file management system 350 for the data instance associated with the group. For example, access rights may be granted for the content manager to write event files on the file management system instance and for the attendees to read event files. The group management system 310 may also provision the calendar instance to add permissions on the calendar instance for the group members. For example, the scheduler may be given access rights to update the event instance on the calendar and attendees may be given access rights to read event information.

Once the access rights are assigned, a group member can access the event instance using, for example, an application connected to the event management system 300. In an example, a group member such as the user U3 who has been assigned the role of the scheduler accesses the event instance by accessing the calendar management system 340 to update the calendar instance using calendar management system APIs. In response, the calendar management system calls a group management system API to determine if the user is a member of the group and its' associated role. The calendar management system subsequently checks calendar instance ACL to confirm if the user's role within the group provides him access to the group calendar. When the calendar management system determines that the user is a member and has the required access rights, the user is allowed to make the desired changes. In another example, a user who has been assigned the role of content manager such as the user U2 tries to update a presentation file associated with an event instance by accessing the file management system 350. In response, file management system 350 calls a group management system API to determine if the user is a member of the group and its' associated role. The file management system 350 subsequently checks the ACL of presentation file to confirm if the user's role within the group provides him access to the file.

The data store 330 functions as a repository in which information associated with all directory hosted identities with the organization (e.g., users, groups, application, etc.) are stored. The data store 330 also stores configuration data such as application manifest of applications such as the group management system 310, calendar management system 340 and file management system 350. Moreover, the data store 330 stores dynamic data like profile of users such as users U1, U2, U3 and groups the user(s) are member of and their roster-scoped roles within those group. Furthermore, the data store 330 stores the ACL for all groups in the organization. Although shown as a single data store, the data store 330 may be representative of multiple storage devices and data stores. Furthermore, although the data store 330 is shown as being part of the contextual role management system 114, one or more elements (e.g., storage mediums) of the data store 330 may be provided in separate storage servers or other types of servers.

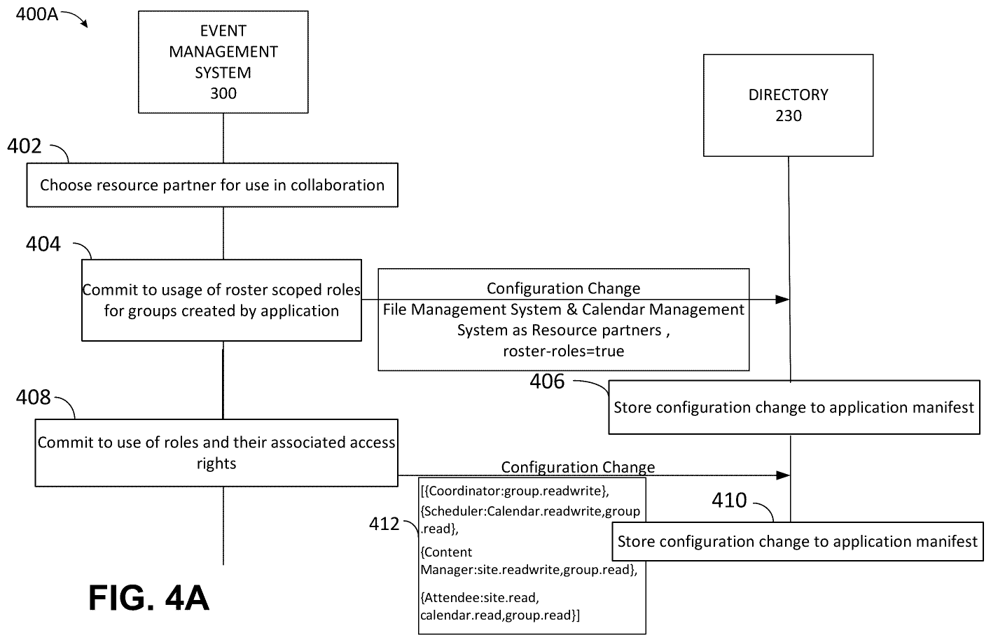

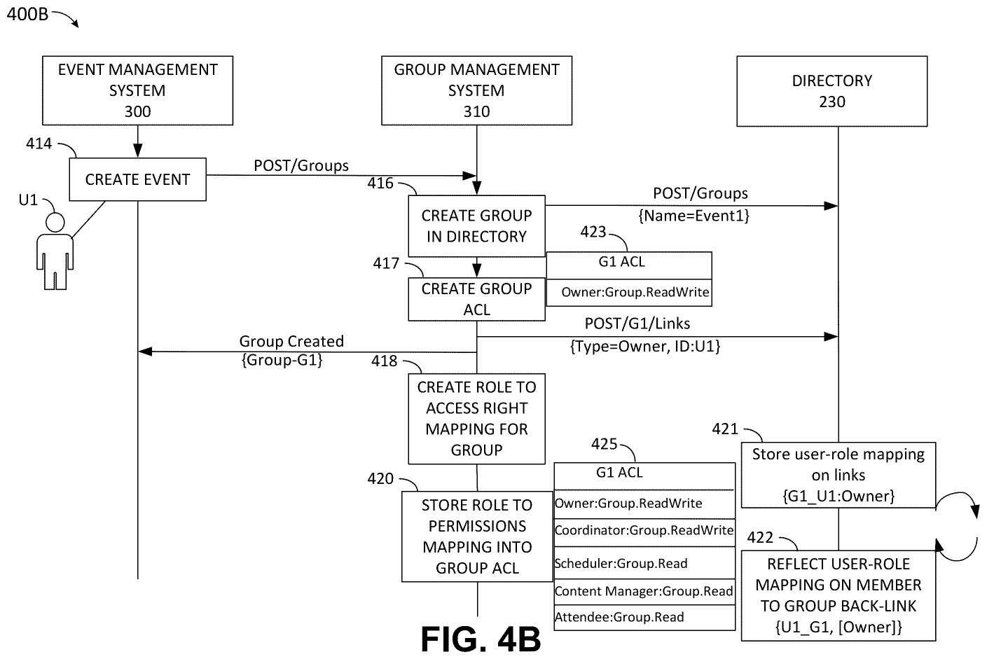

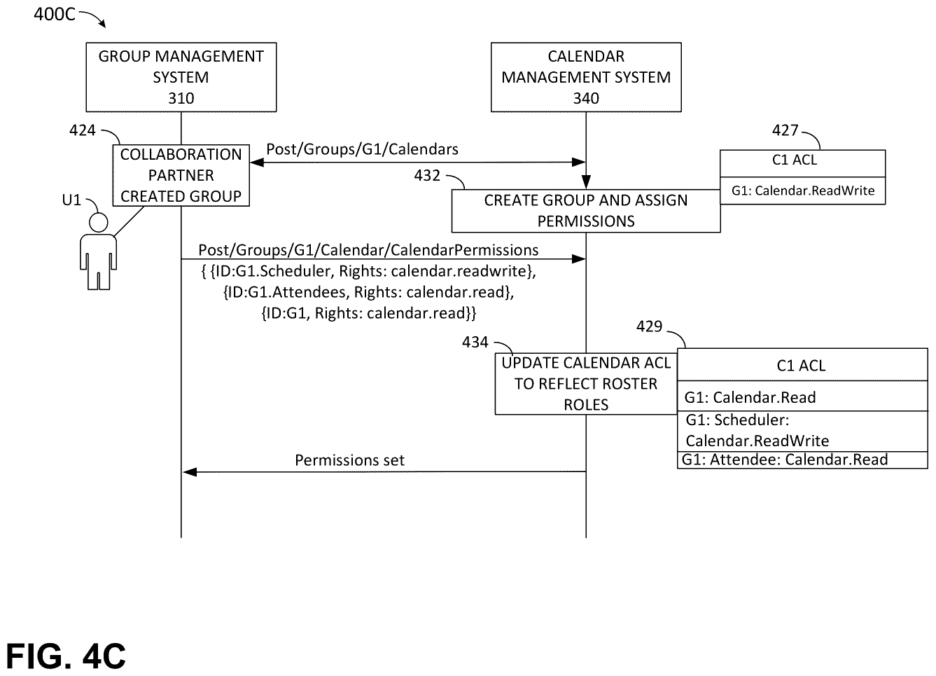

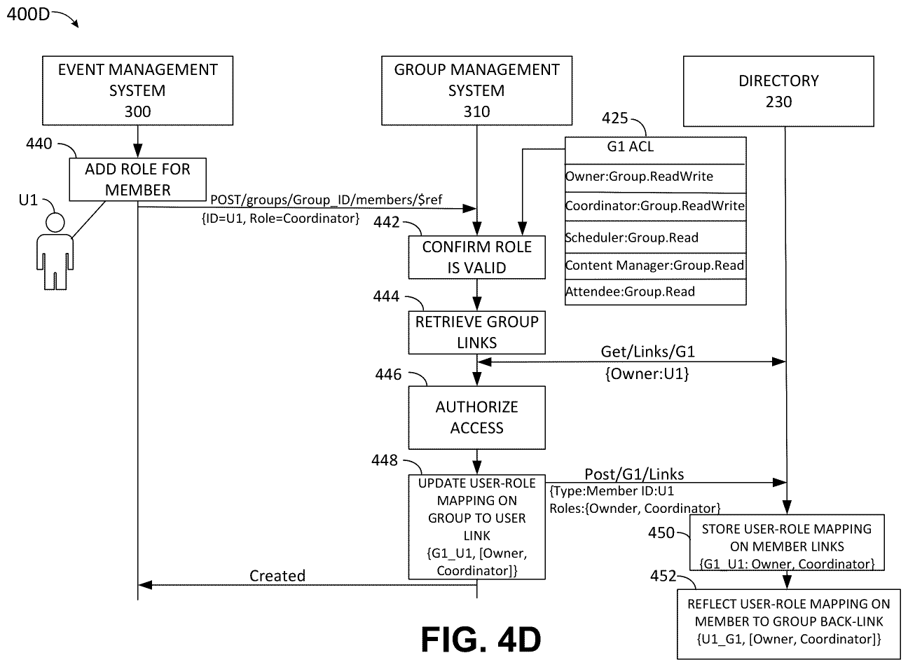

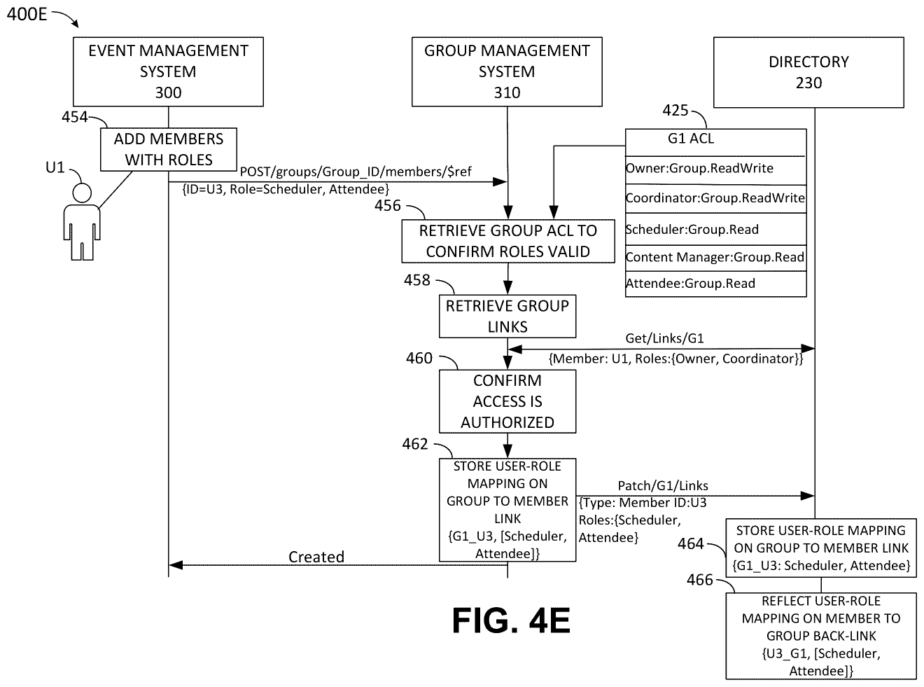

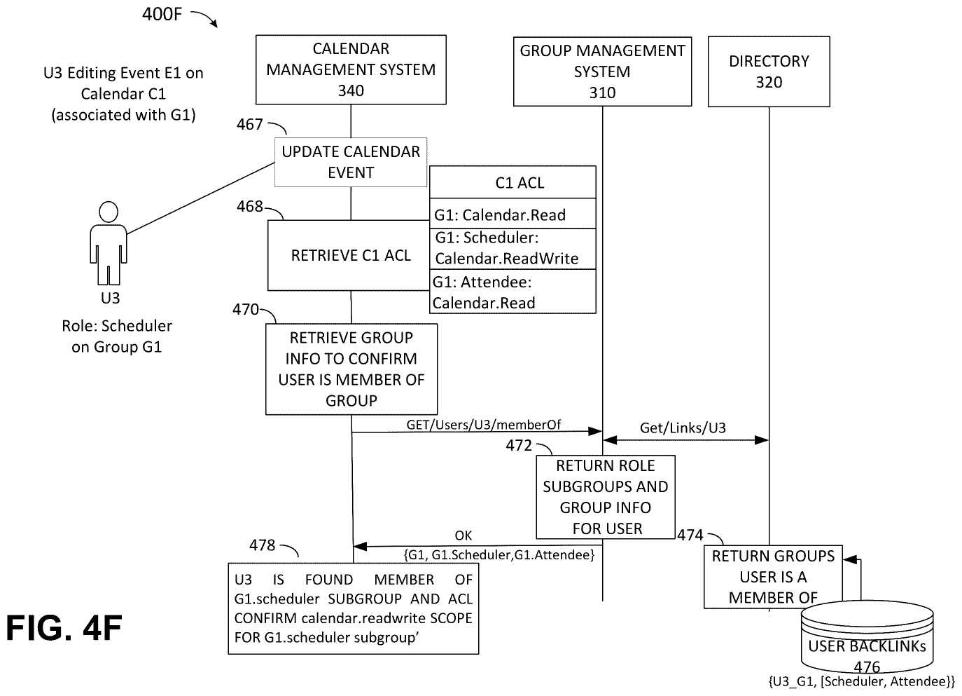

FIGS. 4A-4F are flow diagrams depicting example methods for providing access control to various resources based on roster-scoped roles. FIG. 4A is a flow diagram depicting an example method 400A for configuring a collaboration partner such as an event management system 300 to offer access control to resource partners such as the calendar management system 340 and file management system 350 based on roster-scoped roles. Method 400A begins with the event management system 300 choosing a resource partner for use in collaboration, at 402. Method 400A then proceeds to commit to usage of roster-scoped roles for groups created by the event management system 300, at 404. These configuration changes are then submitted to the directory 230 which stores the configuration change in an application manifest or another file and/or data store, at 406. In this manner, the event Management System 300 records its' preference to use roster scoped roles for this collaboration scenario. This step helps identify such groups differently and unique identification contributes to efficiency. For example, role-subgroups may be looked for and cached only for groups that support roster-scoped roles. Role-subgroup is a subset of group members who are assigned a certain role in a group.

The event management system 300 then commits to using the roster roles and their associated access rights for its' use, at 408. The event management system 300 also defines roster scoped roles and associates them with access rights mapping. Access rights are on group and group connected surfaces. For example, {Coordinator: group.readwrite}, and {scheduler: group.read,calendar.readwrite}. This means that for a group, group members with Coordinator roles will be able to perform group and membership CRUD, whereas group members with a Scheduler role will be able to manage the group calendar and will only be able to read the group roster. An example of roster roles and their associated access rights is displayed in the roles to access rights map 412 which displays an example roles/access rights mapping for the event management system 300. The roles to access rights mapping configuration change is transmitted to the directory 230 and stored in the application manifest of event management system, at 410.

Access rights represent access control provided to a user with a given role in a group. As such, access rights are defined and assigned to each role. These roster-role to access rights mappings may be done by the application developer or programmer who designs the application (e.g., collaboration partner) and/or adds roster-scoped role features to an existing application. Access rights themselves are resource partner specific, e.g. calendar.readwrite is specific to calendar management system. In some implementations, this roster roles to access rights mapping is configured via use of an API. In this example, they are defined in configuration files or in the application manifest. For example, the event management system 300 defines roles and their mappings to access rights on group instances and group connected resources for the given application and these settings are stored in the application manifest for the event management system or in an equivalent document.

An example of defined roles are coordinator, scheduler, content manager and attendee. In an example, coordinators are assigned the role of coordinating events. They may be assistants or administrators who do not control the event schedule or content, but are able to handle participation, for example, by adding users to the event. Schedulers are authorized to schedule and manage an event calendar associated with the group. Content managers may be content creators or document authors that manage files on the data storage instance associated with the group. In an example, all group members except for coordinators are able to attend events. Thus, schedulers and content managers are also attendees. All users belonging to the group may also be considered members.

The roles assigned to a group are mapped to access rights on group metadata and/or on group connected resources. This mapping is then stored in the application manifest of the collaboration partner (e.g., event management system) or inside a scenario configuration in implementations where roles are stored as roster-scoped roles. Table 1 depicts an example of roles and their associated access rights for an event management system. As depicted, the coordinator role has read/write access rights to the group instance, the scheduler has read/write access rights to the calendar instance (e.g., the event calendar instance) and read access right to the group instance, the content manager has read/write access rights to the file management site associated with the event, and read access right to the group instance, and the attendee role has read access right to the group instance, file management site and the calendar instance. Thus, attendees for an event backed by a group are able to read the group membership and metadata and are able to access files stored on the data resource provisioned for the event. Moreover, attendees are able to view calendar event notifications for the event.

TABLE 1

| | Group & | | |
|---|---|---|---|
| | membership | Calendar | SharePoint |
| Role | CRUD Rights | access rights | access rights |
| Coordinator | ′group.readwrite′ | None | None |
| Scheduler | ′group.read′ | ′calendar.readwrite′ | None |
| Content | ′group.read′ | None | ′site.readwrite′ |
| Manager | | | |
| Attendees | ‘group.read’ | ‘calendar.read’ | ‘site.read’ |

In an example, a collaboration partner which is an event management system has a recurring event configuration created for a group of people within a tenant. The group may be referred to as Group G1 and be defined to include 8 users, thus G1={U1, U2, U3, U4, U5, U6, U7, U8}. Group G1 also has an associated calendar C1 and a file management site S1. The file management system site has file(s) S1={S1F1, S1F2, S1F3 . . . }. Calendar C1 has multiple events scheduled C1={C1E1, C1E2, C1E3 . . . }. For Group G1, role assignment is accomplished by making the group management API calls to assign roles to users. For example, the coordinator role may be assigned to U1 and U2, the scheduler role may be assigned to U3 and U4, the content manager role may be assigned to U5 and U6 and the attendee role may be assigned to U3, U4, U5, U6, U7, U8. Thus, Coordinator={U1,U2}, Scheduler={U3,U4}, Content Manager={U5,U6}, and Attendees={U3,U4 . . . U8}. For this Group G1, U1 is also group creator-owner. All users from U1 to U8 are also group members.

FIG. 4B is a flow diagram depicting an example method 400B for creating an event and associating the event with a group roster. Method 400B may be invoked by a user such as U1 using an application that offers roster-scoped role management in association with an event (e.g., event management system 300). In an example, a user may use a UI screen of an management system 300 to create an event, at 414. Thus, the event is created using the event management system 300 which works in coordination with the group management system 310 and directory 320 to create the event and assign roles to group members. Creating an event may include assigning a name for the event (e.g., event title/subject) and/or selecting event members. The user who creates the event is considered the owner of the group and has read/write access rights to the group instance. Once the request to create the event is received, the event management system 300 transmits a message to the group management system 310 to create a group for the event in the directory, at 416. The message may include information about the event such as the name of the event, as well as information about the group (e.g., users who were selected as members of the group).

After creating the group, the group management system 310 creates a group ACL for the group, at 417. The group ACL stores the roles to rights mapping for the roles of the group members. The group ACL may be stored in Directory 230. For example, if the only group member at this stage is the owner, the ACL stores the mapping of Owner:Group.ReadWrite for the group owner. This demonstrates that the owner has read/write access rights to the group instance.

The group management system 310 then reads configuration of caller application and stores the role to access rights mapping (e.g., {role:rights on group instance}) for all roles configured by the caller application on to group instance ACL, at 418. The mapping is then stored into the group ACL, at 420. Access rights in the G1-ACL are ones that can be enforced on the group instance. For example, the Scheduler can do Calendar.ReadWrite along with Group.Read, but the G1-ACL will only show Group.Read for Scheduler role. The group calendar ACL enlists Calendar.ReadWrite for the Scheduler role. This implies the Scheduler can add/modify the calendar C1 attached to the G1, but can only read the group and not modify the group properties (e.g., group description). Thus, roles defined for the event management system when configuring the application are stamped on the group instance ACL and access rights in the group ACL are enforced on the group instance. The group ACL 425 displays an example of a group ACL. For example, the group ACL 425 shows that the role of scheduler is allowed to perform Group.Read.

The role information for every user added as group member is stored on the directory links, at 421. An example of this is the G1 to U1 mapping for the owner. User U1's role as owner is stored on Group->user link and user->group link. The directory has directory objects (identities) and directory links. Directory links store relationship information between identities related. For example, in this case the group links helps answer the question “Get me all ‘Owners’ of group G1.” User role mappings on member to group are reflected on back-links, at 422. Thus, the group back-links helps answer the query “Get me all groups U1 is owner of.”

FIG. 4C is a flow diagram depicting an example method 400C for provisioning a group connected calendar resource instance for a group. Method 400C may be invoked after the event management system 300 creates a group. The group management system 310 provisions the group calendar instance After the group has been created, at 424 the event confirming group creation triggers the creation of a group calendar instance as a group connected resource for the group. The calendar instance C1, honors the group roster, G1. All participants of the group have read-write access for events created in the group calendar. Calendar instance C1 may contain many events. Thus, once created, users may add one or more event instances on the group calendar. For example, a recurring event such as weekly status meetings for a team may add one event every week to the group calendar.

The calendar management system 340 creates a new group calendar associated with the newly created group and assigns read write permissions for the group, at 432. An example ACL entry on the calendar is represented in 427. Thus, the calendar instance is restricted to the group roster. This may be referred to herein as provisioning. The calendar management system 340 exposes one or more calendar permissions APIs to manage access rights on the calendar instance. These APIs may be used to store access rights mapping on the calendar instance ACL. For example, the role access rights mapping ‘G1.Scheduler:calendar.readwrite’ may be stored on the calendar instance C1 ACL. This implies all members of the group G1 with the scheduler role are able to read/write events on the calendar instance C1. An example of a calendar instance ACL is displayed in the C1 ACL 427, where group G1 is identified as having read-write access rights to the calendar instance.

Calendar permission APIs are used to store role sub-group mapping on the calendar instance C1 ACL. For example, calendar permissions APIs are used to store the ‘G1.Attendee:calendar.read’, ‘G1.Scheduler:calendar.readwrite’ mapping on the calendar instance C1 ACL. This implies that members of group G1 with an attendee role are able to read events from the C1 calendar, whereas schedulers from group G1 will be able to read write events in the calendar C1. Additionally the permissions APIs also give calendar.read access to all other group members who are not schedulers and attendees by setting ‘G1:calendar.read’. This updates the calendar instance ACL as shown in the updated C1 ACL 429. Calendar permissions APIs update the C1 ACLs in the process, at 434. Once the permissions are set, a message is transmitted from the calendar management system 340 to the group management system 310, to inform the group management system 310 that the permissions are set. This illustrates how access rights are enhanced to change default behavior of group connected resources such as the calendar instance C1.

FIG. 4D is a flow diagram depicting an example method 400D for authorizing access to a group instance. Method 400D may be invoked when the user U1 adds a member to a group and/or assigns a new role to a group member, at 440. This may occur when the group member is first added to the group or later, when the group owner decides that a member's role needs to be changed or a new additional role should be assigned to a group member. It is noted that while method 400D shows the process for assigning a role to a group member, a similar process may be performed for any group update such as display name update and the like. In the example of method 400D, the user U1 is attempting to add the role of coordinator to itself. When a user such as the group owner or another group member with correct access rights adds a new group member and/or assigns a role to a group member, a request for the change is transmitted from the event management system 300 to the group management system 310. The group management system 310 then confirms that the requested role is a valid role for the group (e.g., one of the supported roles for the group instance), at 442. This may be done by checking the group instance ACL. At step 444, group links are retrieved from the directory 320. Group links enumerates users that are participants of groups and their roles. The group 1 forward links enlist U1 as the group owner. At step 446, the G1 link response is compared against the G1 ACL to authorize access. Links show U1 as the group owner and group ACL shows the owner role has group.readwrite access. Thus, U1 is authorized to update group G1. This may involve checking the access rights and/or authorization information of the user.

At step 448, the group management system 310 assigns the additional role of Coordinator to U1. This leads to updates in G1->U1 link and U1->G1 Backlinks. This may involve assigning the role to the new group member or updating the role for the group member, as the case may be. At 450, the G1->U1 link is updated with an additional role for U1. For example, U1 is now also marked as a Coordinator along with owner. The U1->G1 backlink also reflects the additional role assigned to U1 (i.e., the additional roles of coordinator along with owner). A ‘created’ message is transmitted from the group management system 310 to the event management system 300 after each of the steps 448, 450 and 452.

FIG. 4E is a flow diagram depicting an example method 400E for adding another user to the group. Method 400E may be invoked when a user attempts to add a group member and assign one or more roles to the new group member, at 454. In an example, the user U1 tries to add U3 as a scheduler and attendee to the group. The process begins when the user U1 utilizes a UI screen associated with the event management system 300 (e.g., UI screen of an application having event management features) to add members with roles. Upon the user invoking a UI element to initiate the process, a message is transmitted from the event management system 300 to the group management system 310 to add a user with the selected role(s), at 454. In response, the group management system 310 retrieves the group ACL instance to confirm that the selected roles are valid, at 456. This may involve transmitting a request to the directory 230 to receive the group ACL. The group management system 310 then retrieves the group links for the group from the directory 230, at 458. The group links lists the members for the group and their associated roles in the group. As a result, the group link should include identifying information for the user attempting to add members.

At step 460, access authorization is confirmed by comparison of the role the user has in the group with access rights associated with that role in the group ACL. Here, group G1 links confirm that the user U1 has owner and coordinator roles in G1. The group ACL confirms that the coordinator role has Group.ReadWrite access rights. As such, U1 is authorized to add U3 to the group since U1 has Group.ReadWrite access rights in the group. Once the permission is confirmed, the new user-role mapping for the additional member is stored in the directory, at 462. At step 464, the role of the user, U3 as a scheduler and attendee is stored in the G1->U3 link. This information is reflected in the U3->G1 back-link, at 466.

FIG. 4F which shows an example method 400F for handling an authorization for a user with certain roster roles. Method 400F may be invoked when a user such as U3 attempts to access a group connected resource on a resource partner. In an example, U3 who has the role of a scheduler tries to patch an event instance E1 associated with the calendar instance C1 which is connected to G1. The process begins when the user U3 utilizes a UI screen associated with the calendar management system 340 to edit an event calendar associated with a group. Upon the user invoking a UI element to initiate the editing process, a message is transmitted to the calendar management system 340 to edit the calendar. In response, the calendar management system 340 retrieves the calendar ACL, at 468. This may involve retrieving the calendar ACL from a data store of the calendar management system 340. In response, group information for one or more members in the group as well as information relating to roles sub-groups are retrieved to confirm the user is a member of the group, at 470. In an example, the calendar ACL shows that the scheduler has read-write access rights to the calendar instance and the roles-sub-group is used to match the calendar ACL.

Group and role sub-groups the user is a member of are returned, at 472. This is made possible because information about groups and role-sub-groups the user is a member of is stored in user to group links. This information is returned at 474. The user backlinks 470 depicts how the role sub-groups the user U3 is a member of is stored in the U3 G1 backlink. At 478, member response information for U3 conveys that U3 is a member of role-subgroup ‘G1. Scheduler’ and the calendar C1 ACL confirms that calendar.readwrite access is available to the G1.Scheduler role-subgroup. Thus, access is authorized. The calendar management system 340 then allows the user to edit the calendar instance.

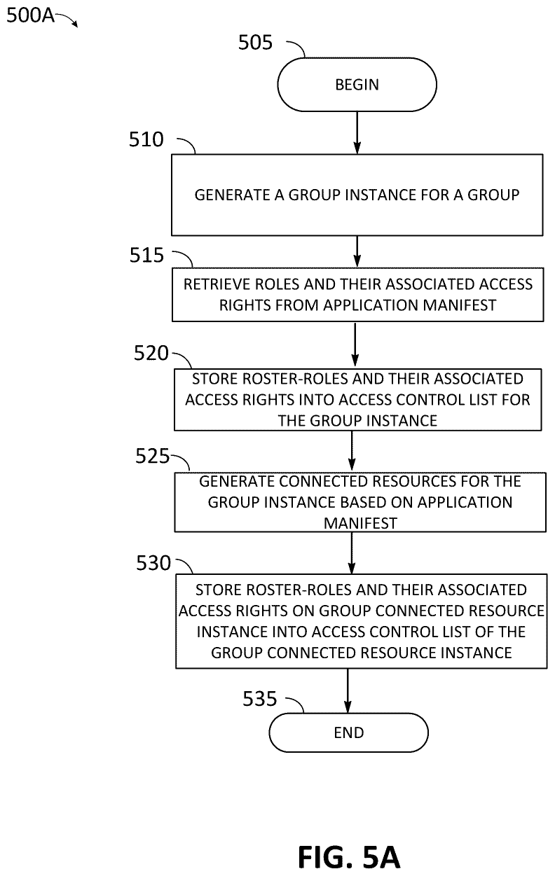

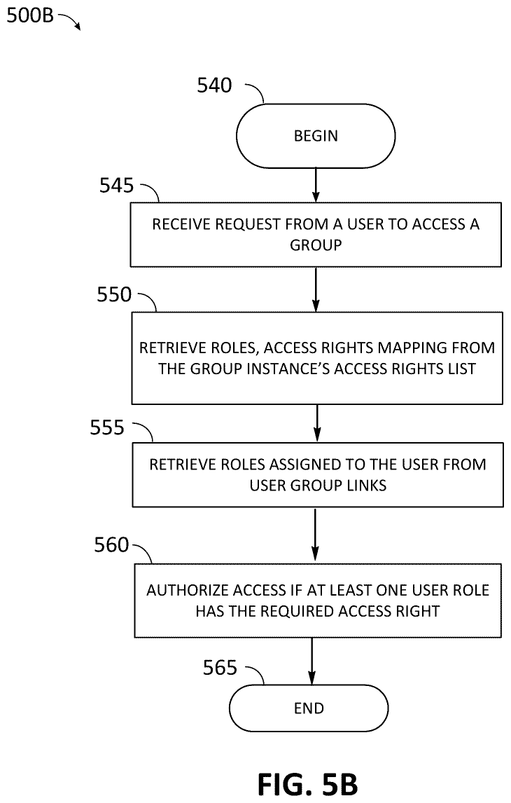

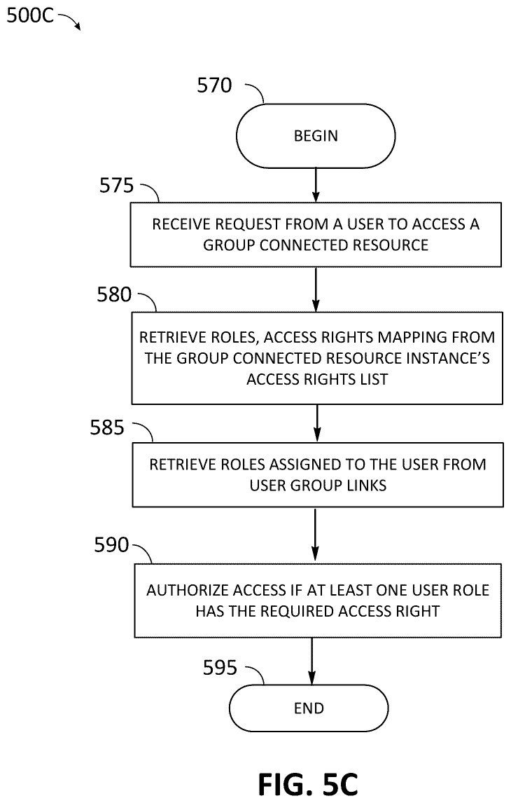

FIG. 5A is a flow diagram depicting an example method 500A for creating a group that utilizes roster scoped roles. One or more steps of the method 500A may be performed by a system such as the contextual role management system 114 of FIGS. 1 and 3.

The method 500A begins, at 505, and proceeds to generate a group instance for a group for use in an application, at 510. This may occur, for example, when a request is received to generate a new group in association with an event or another context. The request may be received via a UI screen of the application (e.g., collaboration partner) in which the group is used or in which the group feature is available for use. The request may be processed via a group management system and/or an event management system when the group is generated in association with an event. The group instance includes a plurality of group members who are users that are identified as being part of the group.

After the group instance is generated, method 500A proceeds to retrieve available roles and their associated access rights from an application manifest, at 515. The retrieved roster-roles and their associated access rights (e.g., access rights on the group instance are stored into an access control list for the group instance, at 520. Method 500A then proceeds to provision connected resource instances for the group instance based on the application manifest, at 525. Once the group connected resource instances are provisioned the roles sub-group and their associated access rights to the group connected resource instances are stored into an access control list for the group connected resource instances, at 530, before method 500A ends, at 535. The roles sub-group is generated from the roster-scope roles. For example, if G1 is the group and scheduler is the roster role applicable in G1, then the roles sub-group is G1.scheduler.

FIG. 5B is a flow diagram depicting an example method 500B for authorizing a user's access to a group. One or more steps of the method 500B may be performed by a system such as the contextual role management system 114 of FIGS. 1 and 3.

The method 500B begins, at 540, and proceeds to receive a request from a user to access a group, at 545. In response, method 500B retrieves roles and their access rights mapping from the group instance's access rights list, at 550. Next, roles assigned to the user are retrieved from the user group links, at 555. The access rights list and roles assigned to the user are then compared to authorize access to the group instance, at 560, when at least one user role for the user has the required access rights. Authorization is either granted or denied based on this determination before method 500B ends at 565.

FIG. 5C is a flow diagram depicting an example method 500C for authorizing a user's access to a group connected resource. One or more steps of the method 500C may be performed by individual resource partners such as resource partner 152 of FIG. 1.

The method 500C begins, at 570, and proceeds to receive a request from a user to access a group connected resource, at 575. In response, method 500C retrieves roles sub-groups and their access rights mapping from the group connected resource instance's access rights list, at 580. Next, roles assigned to the user are retrieved from the user group links, at 585. The access rights list and roles assigned to the user are then compared to authorize access to the group connected resource instance, at 560, when at least one role sub-group to which the user belongs has the required access rights. Authorization is either granted or denied based on this determination before method 500C ends at 595.

It should be noted that while an event management system, a calendaring service and a file management service are discussed in this disclosure, these elements are simply examples of collaboration partners and resource partners. Other types of collaboration partners and resource partners may be used in other implementations. For example, an email application may function as a collaboration partner, when it stores configuration information that defines a role such as content manager for groups in that application and creates an access rights mapping for the content manager role that allows the content manager to read-write documents for the group to which it belongs. In another example, the email application may define a scheduler role that enables the scheduler to edit meetings sent to the group calendar. In yet another example, a virtual meeting application (e.g., Teams) may define a role such as coordinator for shared channel or stand-alone channel and have allow coordinators to add more users to the group. Many other alternative implementations are possible.

Thus, in various implementations, an application manifest for a collaboration partner stores a list of resource partners to be used for realizing a planned collaboration scenario. The application manifest for the collaboration partner also stores the collaboration partner's willingness to user roster-scoped roles. Furthermore, the application manifest for the collaboration partner stores a role-string, access rights mapping for roster scoped roles supported by the collaboration partner. This mapping may be referred to as a role-rights mapping. Access rights within the role-string, access rights may be access rights on a group instance and on group connected resource instances. Access rights specific to a group identity are as defined by a group management system, while access rights to a group connected resource are as defined by the collaboration partner. The group management system creates groups in a directory for collaboration partner applications (triggered by an end user) and stores a field indicating that the group may contain sub-groups of identities for each roster scoped role. For example, Roster-Role-Aware-Group’ (RRAG=true) group. This information is useful during caching (e.g., for engineering optimization), to uniquely identify groups that have roster role-subgroups. The group management system also stores role-subgroup and their access rights on the group instance in an ACL of the group instance. Moreover, the group management system stores role-subgroup(s) the user is a member of in group user links. This mapping will help answer role queries such as get all group participants with a certain role. The directory implementation copies the role-subgroup information for every user into user group links. This will help in responding to role queries such as get all groups where the user has a certain role. Furthermore, the group management system provisions and/or creates group connected resources along with the group instance creation.

The group management system stores a mapping of role-subgroups and their access rights on the group connected resource instance in the group connected resource instance ACL. This can be achieved by utilizing APIs exposed by a group connected resource partner. The group management system returns role-subgroups, a user is a member of by querying links information. The group management system authorizes participant addition or group metadata update onto a group instance based on the role-Subgroup, access rights on group instance mapping stored on the group instance ACL and role of the caller within the group. For example, a user having a coordinator role will be able to add an attendee (right: group.read.all) to the group. However, attendee will not be able to add other attendees to the group. Authorization consists of retrieving role-subgroups the user is a member of and comparing the role-subgroup with the group ACL to determine if one of the role-subgroups permit access to the requested operation.

A group connected resource provider authorizes resource access by comparing the role-subgroup, access rights on the resource instance in the resource instance ACL with the roles sub-group the user is a member of. For example, if the user is a member of role-subgroup schedulers, the user will be able to update a group calendar item, since the scheduler role-subgroup has calendar.readwrite access right in the calendar instance ACL. Authorization consists of retrieving role-subgroups the user is a member of and comparing the role-subgroup with the group connected resource instance ACL to determine if one of the role-subgroups permit access to the requested operation. Thus, in implementations, the role-subgroup information is stored in group connected resource instance ACLs. The system also ensures the group management system returns role-subgroups a user is a member of as part of an API (e.g., member Of API). These steps ensure pre-existing string comparison between the caller and group connected resource instance ACL does not need any change for authorization to function properly.

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as client devices, native application providers, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764 such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-7) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the foregoing detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor alone or in combination with other processors, cause the data processing system to perform functions of:
generating, via a group management system, a group in a collaborative environment provided in an application by generating a group instance for the group;
retrieving one or more roles and one or more access rights associated with the one or more roles from an application manifest of the application;
storing the retrieved one or more roles and the one or more access rights associated with the one or more roles into an access control list for the group instance;
generating a group connected resource instance for the group instance based on the application manifest; and
storing the one or more roles and one or more access rights associated with the one or more roles' access rights to the group connected resource instance into an access control list for the group connected resource instance.

2. The data processing system of claim 1, wherein the application manifest stores a configuration change for the application that identifies the application as utilizing roster scoped roles for groups created by the application.

3. The data processing system of claim 1, wherein an application manifest stores a list of roles and their associated access rights for roles supported by the application.

4. The data processing system of claim 1, wherein at least one of the access control list for the group instance and the access control list for the group connected resource instance are stored in a directory.

5. The data processing system of claim 1, wherein the executable instructions when executed by the processor alone or in combination with other processors, cause the data processing system to further perform functions of:
receiving a request from a user to access the group instance;
retrieving the one or more roles and the one or more access rights associated with the one or more roles from the access control list for the group instance;
retrieving one or more roles assigned to the user from one or more user group links;
authorizing the user's access to the group instance when it is determined that at least one of the one or more roles assigned to the user have an access right required for the access.

6. The data processing system of claim 5, wherein authorization is provided by using at least one of forward links or backward links.

7. The data processing system of claim 5, wherein the request for access to the group instance includes at least one of a request to add another user or a request to assign a role to one or more users.

8. The data processing system of claim 1, wherein the executable instructions when executed by the processor alone or in combination with other processors, cause the data processing system to further perform functions of:
receiving a request from a user to access the group connected resource instance;
retrieving the one or more roles and the one or more access rights associated with the one or more roles from the access control list for the group connected resource instance;
retrieving one or more roles assigned to the user from one or more user group links;
authorizing the user's access to the group connected resource instance when it is determined that at least one of the one or more roles assigned to the user have an access right required for the access.

9. The data processing system of claim 8, wherein authorization is provided by using at least one of forward links or backward links.

10. The data processing system of claim 1, wherein the group connected resource instance is for at least one of a calendar instance or a file management system instance.

11. A method for providing access control to one or more resources based on roster scoped roles comprising:
generating, via a group management system, a group in a collaborative environment provided in an application by generating a group instance for the group;
retrieving one or more roles and one or more access rights associated with the one or more roles from an application manifest of the application;
storing the retrieved one or more roles and the one or more access rights associated with the one or more roles into an access control list for the group instance;
generating a group connected resource instance for the group instance based on the application manifest;
storing the one or more roles and one or more access rights associated with the one or more roles' access rights to the group connected resource instance into an access control list for the group connected resource instance; and
providing access to at least one of the group instance or a group connected resource associated with the group based on the access rights list instance.

12. The method of claim 11, wherein the group connected resources include application resources and data resources.

13. The method of claim 12, wherein the application resources includes a calendar instance associated with the group and data resources includes a file management site associated with the group.

14. The method of claim 13, wherein the calendar instance includes one or more events associated with the group.

15. The method of claim 11, wherein access to the one or more resources is provided based on at least one of access rights in the group connected resource instance access rights list instance and user group links associated with a user requesting access.

16. The method of claim 11, wherein the group management system stores a list of group members and their associated roles to user group links.

17. The method of claim 11, wherein the user group links are stored in a directory.

18. A non-transitory computer readable medium on which are stored instructions that, when executed, cause a programmable device to perform functions of:
generating, via a group management system, a group in a collaborative environment provided in an application by generating a group instance for the group;
retrieving one or more roles and one or more access rights associated with the one or more roles from an application manifest of the application;
storing the retrieved one or more roles and the one or more access rights associated with the one or more roles into an access control list for the group instance;
generating a group connected resource instance for the group instance based on the application manifest; and
storing the one or more roles and one or more access rights associated with the one or more roles' access rights to the group connected resource instance into an access control list for the group connected resource instance.

19. The non-transitory computer readable medium of claim 18, wherein security context information associated with a user of the application includes at least one of one or more roles and one or more subgroups the user is associated with.

20. The non-transitory computer readable medium of claim 18, wherein authorizing the user to access a resource is done by retrieving the security context information associated with the user and comparing the security context information with the access rights list for the group instance or with the access rights list for the group connected resource instance.
